(19) United States
(12) Patent Application Publication
(10) Pub. No.: US 2006/0188120 A1
(43) Pub. Date: Aug. 24, 2006

(54) Multiple active coil speaker

(76) Inventor: Michael Fisher, Auburn, WA (US)

Correspondence Address: BLACK LOWE & GRAHAM, PLLC, 701 FIFTH AVENUE, SUITE 4800, SEATTLE, WA, 98104, US

(21) Appl. No.: 11/064,591

(22) Filed: Feb. 23, 2005

(51) Int. Cl. H04R 1/02; H04R 1/20; H04R 9/06

(52) U.S. Cl. 381/338; 381/401; 381/396

(57) ABSTRACT

A voice tube assembly for a loudspeaker comprising a basket, a cone, and a spider includes a first magnet. The first magnet is configured for attachment onto the basket and has a principle axis. A second magnet, the second magnet configured the magnet being coaxial with the first magnet and spaced apart from it. A voice tube of non ferrous material includes a cylindrical sleeve having a first extremity, a second extremity, and a cylinder axis. The cylinder axis is arranged to coincide with the principle axis. A first voice coil of conductive wire is wrapped around the first extremity in operational proximity to the first magnet. A second voice coil of conductive wire is wrapped around the second extremity in operational proximity to the second magnet.

### FIELD OF THE INVENTION

This invention relates to speakers, and more particularly, to electromagnetic drives for speakers.

### BACKGROUND OF THE INVENTION

Ernst W. Siemens taught a “dynamic” or moving-coil transducer including a circular coil of wire positioned in a magnetic field surrounding a permanent magnet and supported so that it could move axially within the magnetic field. For his “magneto-electric apparatus” configure for “obtaining the mechanical movement of an electrical coil from electrical currents transmitted through it” based on an application filed on Jan. 20, 1874, and was granted U.S. Pat. No. 149,797 on Apr. 14, 1874.

The first coil-driven direct-radiator loudspeaker known as Phonetron, implemented the magneto-electric to drive a cone as taugh in U.S. Pat. No. 1,847,935 filed on Apr. 23, 1921, by C. L. Farrand. The Phonetron was well-received as a substitute for the acoustic amplifying horns used by table radios.

Still based on the voice coil and magnet drive, the basic configuration of the coil-driven loudspeaker has changed little. The voice coil is mounted so that it can move freely inside the magnetic field of a strong permanent magnet. A speaker cone is attached at its apex to the voice coil and attached at a periphery with a flexible mounting to an outer ring of a speaker support. The cone and flexible mounting defines a definite “home” or equilibrium position for the coil with an elasticity of the mounting structure. Much like a pendulum or a mass on a spring, a free cone resonant frequency characterizes the cone's response to a exciting signal through the coil.

The resonant frequency can be determined at the design phase by adjusting the mass and stiffness of the cone and the mass of the voice coil. Additionally the movement of the cone can be damped and broadened by selecting of the construction materials and dimensions. The natural mechanical frequency of vibration, however, is always there and enhances the response of the cone to exciting signals in a frequency range near the resonance frequency.

One additional means of minimizing the dominance of the resonance frequency in the frequency response of the driven cone is to optimize a speaker enclosure is to counteract the resonance of the cone at the resonant frequency. Unfortunately deadening an enclosure's response cannot exactly match the resonant response at the resonant frequency. Responses outside of the resonant range will also suffer distorting the frequency response of the cone.

The distortion of sound due to the dominant response of the resonant frequency is not the only shortcoming of the traditional configuration of a loud speaker. Additionally, the conventional design fails to dissipate heat well as it also tends inherently to limit the length of travel for the voice tube. The failure to dissipate heat limits the selection of materials for the magnets to generally ferrous materials. Ferrous magnets tend to retain magnetism at higher temperatures while they are larger and by virtue of their size further limited in the ability to dissipate heat generated in the work of moving the voice tube.

In some less extreme applications, designers have substituted Neodymium Iron Boron (NdFeB) for ferrous magnets. Unfortunately, magnetic properties of NdFeB deteriorate rapidly above about 130 Centigrade, depending on the grade of material, and the permeance coefficient of the magnet in operation. The higher the permeance coefficient the magnet operates at, the higher the temperature it will withstand, however, very few designs will allow the use of NdFeB in a high-power loudspeaker of conventional design without degradation.

A type of speaker enclosure that has allowed for greater efficiency and allowing for distribution of the work function of the drivers has been used primarily for subwoofers and bass drivers. The isobaric configuration uses a small, sealed enclosure with two or more generally bass drivers facing each other (typically, one inside the box facing out and the other outside the box facing in at its counterpart) and wired out of phase. The primary advantage of this type of configuration is that the enclosure is small—about half the size of a sealed enclosure for the same output.

In at least one configuration, isobaric enclosures leave one driver essentially hanging out in the open air making it a somewhat challenging configuration to achieve due to aesthetics and the need to protect the driver outside the box. Isobaric enclosure configuration are useful to increase the power of the output but there is no mechanical coupling between the voice coils to yield even further mechanical advantage possible. Where one of the two drivers is not driven, all of the efficiencies cease. There is no way to alternately energize the driver coils.

Recently, small accelerometers have been mounted on the cone to measure frequency response, have yielded accurate instantaneous information as to the movement of the cone in response to the exciting signal. With the accurate instantaneous information, amplifiers have been designed that attenuate component frequencies of the exciting signal within the range surrounding the resonant frequency.

Still simple attenuation of frequencies is not enough to solve the distortion, however, no matter how closely the actual movement of the cone coincides with expected pressure troughs and crests in the acoustic sound wave, the amplifier is configured to represent. The mass of the diaphragm or cone is much, much, greater than the mass of the air it is acting on. By an analogy to electrical circuits, the impedance of the speaker is not equal to the impedance of the air. The impedance mismatch decreases the total power transfer thereby causing the driven cone to be very inefficient at producing an acoustic wave.

Therefore, there exists a need to minimize resonance effects of a loudspeaker, to produce an acoustic wave that most closely represents a desired acoustic wave, to increase the efficiency of the loudspeaker output, and allows for a better distribution of the generated heat.

### SUMMARY OF THE INVENTION

The present invention provides a voice tube assembly for a loudspeaker, the loudspeaker including a basket, a cone, and a spider includes a first magnet. The first magnet is configured for attachment onto the basket and has a principle axis. A second magnet, the second magnet configured the magnet being coaxial with the first magnet and spaced apart from it. A voice tube of non-ferrous material includes a cylindrical sleeve having a first extremity, a second extremity, and a cylinder axis. The cylinder axis is arranged to coincide with the principle axis. A first voice coil of conductive wire is wrapped around the first extremity in operational proximity to the first magnet. A second voice coil of conductive wire is wrapped around the second extremity in operational proximity to the second magnet.

In accordance with further aspects of the invention, the voice tube assembly of claim 1, further includes a heat sink. The heat sink is fabricated of nonferrous material. The heat sink is configured to engage a first surface of the first magnet and pole piece assembly and a second surface of the second magnet and second pole piece assembly thereby to maintain the spaced apart relationship of the first and the second magnet and pole piece assemblies. Advantageously, the reflexive relationship between magnets and voice coils in a speaker allows the interchangeable design of the inventive loudspeaker. Thus, where the voice tube assembly may include the permanent magnets, the design allows the voice coils to be fixed to the basket. Because the magnetic repulsion or attraction works equally on the magnet and voice coil, this reflexive interchangeability of magnets and voice coils but this reflexive interchangeability is not unique to the invention.

In accordance with still further aspects of the invention, the heat sink is elongated in shape and has a heat sink axis that is coaxial with the principal axis. The heat sink may advantageously be substantially cylindrical in shape. An outer surface of the heat sink may include a bearing surface. The bearing surface includes a Teflon® surface to guide the voice tube without contributing to static friction.

In accordance with other aspects of the invention, the voice tube assembly includes an outer surface that is finned to dissipate heat. The heat sink may advantageously include vent holes and a finned inner surface.

In accordance with other aspects of the invention, the voice tube is configured to slidingly engage the first magnet assembly; the first magnet assembly includes a first ferrite pole piece. Advantageously, the first ferrite pole piece may include vents configured to allow movement of air past the first ferrite pole piece. Similarly, the second magnet may include a second ferrite pole piece. The second ferrite pole piece, as well, may include vents configured to allow movement of air past the second ferrite pole piece.

In accordance with still other aspects of the invention, the first voice coil is configured to impart a first electromotive force upon the voice tube when a first current passes through the coil. The second voice coil is configured to impart a second electromotive force upon the voice tube when a second current passes through the coil. The second current may be advantageously selected to impart the second electromotive force to suitably enhance the first electromotive force imparted upon the voice tube thereby to produce a desired acoustic wave based upon the first current. Likewise, the first current may be selected to impart the first electromotive force to suitably enhance the second electromotive force imparted upon the voice tube thereby to produce a desired acoustic wave based upon the second current.

An additional aspect of the invention is the advantageous use of non-active coils as components of accelerometers as passive coil generators generating signals upon movement past the permanent magnet and indicative of voice tube movement. Such signals advantageously allow the employment of the generated signals to allow a feedback loop configuration in a switching network thereby to optimize the driving forces on the voice tube.

In accord with still further aspects of the invention multiple coils may advantageously be used. For instance, a voice tube with three voice coils may advantageously interact with two affixed magnets.

In accordance with still further aspects of the invention, a second current is generated in the second voice coil due to movement of the voice tube. The second current may be measured to determine a magnitude and displacement of the movement of the voice tube.

### BRIEF DESCRIPTION OF THE DRAWINGS

The preferred and alternative embodiments of the present invention are described in detail below with reference to the following drawings:

FIG. 1 illustrates an exploded view of parts of an example loud speaker with the inventive voice coil assembly in accordance with an embodiment of the present invention;

FIG. 2 illustrates a cutaway side view of the speaker of FIG. 1;

FIG. 3 illustrates a cutaway side view of the inventive voice tube assembly components of the speaker shown in FIGS. 1 and 2; and

FIGS. 4 and 5 are perspective views of a heat sink and a voice tube of the voice coil assembly shown in FIGS. 1 and 2.

### DETAILED DESCRIPTION OF THE PREFERRED EMBODIMENT

By way of overview, a voice tube assembly for a loudspeaker comprising a basket, a cone, and a spider includes a first magnet. The first magnet is configured for attachment onto the basket and has a principle axis. A second magnet, the second magnet configured the magnet being coaxial with the first magnet and spaced apart from it. A voice tube of non-ferrous material includes a cylindrical sleeve having a first extremity, a second extremity, and a cylinder axis. The cylinder axis is arranged to coincide with the principle axis. A first voice coil of conductive wire is wrapped around the first extremity in operational proximity to the first magnet. A second voice coil of conductive wire is wrapped around the second extremity in operational proximity to the second magnet.

A conventional loudspeaker is generally constructed of a metal frame or basket to which is attached, by means of an elastic surround, a cone, made of paper, plastic, or, rarely, metal. Near an apex of the cone, a coil of wire (the “voice coil”) is wound around an extension of the cone, called a “former.” The voice coil is suspended within a magnetic field emanating from a permanent magnet so that the voice coil lies in a narrow gap between the magnet pole pieces and a front plate.

The voice coil is kept centered by a “spider” that is attached to the frame or basket and to the voice coil. The spider is a circular piece of fabric with multiple pleats, which holds the speaker's voice coil in the magnetic gap. The spider acts like a spring that returns the voice coil (and hence, the driver) back to its resting position. (The name comes from the early days of audio when small plastic bands, said to resemble a spider's legs, were used.)

In some speakers, a rear vent allows air to pass through vents in the magnet when the cone is moving, but a dust cap on the cone keeps air from getting in through the front. In others, a dust cap is the vent, made of a permeable material such as cloth.

A rubber, foam, or sometimes cloth surround at the outer edge of the cone allows for flexible movement. The surround around the periphery of the cone limits how far the driven cone can move past its resting position in either direction.

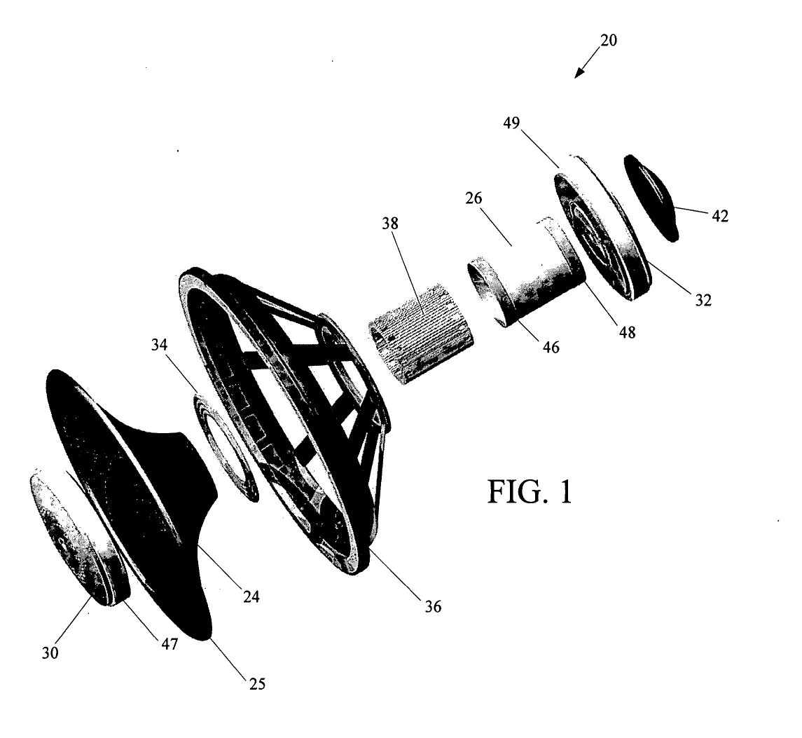

Referring to FIG. 1, an inventive loudspeaker assembly 20 shares many of the same elements found in a conventional construction. The inventive loudspeaker 20 includes a speaker cone 24 with a resilient surround 25, a voice tube 26, a spider 34, and a speaker basket 36. Inventive aspects of the loudspeaker include a first magnet 47 with a first pole piece 30, a first coil 46 wrapped around a first end of the voice tube 26, a second coil 48 wrapped around a second end of the voice tube 26, and a second magnet 49 with a second pole piece 32. Advantageously, due the elongated nature of the voice coil 26 it is optionally configured to receive a heat sink 38, and a vented aft cap 42 to ensure more optimal heat exchange than conventional designs as the voice coil 26 to pump air by pistonic action.

In the presently preferred embodiment, the second magnet 49 is seured to the basket 36 by means of bolts (not shown). The heat sink 38 offsets the first magnet 47 from the second magnet 49 while maintaining a spatial relation to the basket 36 and to each other. Grooves defined in aspects of the first magnet 47 and the second magnet 49 are advantageously configured to receive the heat sink 38, while the first and second ends of the voice tube 26 are enclosed by a second set of grooves between the first magnet 47 and the first pole piece 30 and the second magnet 49 and the second pole piece 32.

The first ferrite pole piece 30 concentrates a magnetic field around the first magnet 47 and the second ferrite pole piece 32 concentrates a magnetic field around the second magnet 49. Additionally, by holding the first magnet 47 in fixed spatial relationship along the axis of the voice tube 26 magnetic flux between the first magnet 47 and the second magnet 49 is concentrated to enhance the electromotive forces generated upon exciting either the first voice coil 46 or the second voice coil 48.

The voice tube 26 is allowed to move axially within the second defined grooves in response to energizing either or both of the first voice coil 46 and the second voice coil 48. The spider 34 resiliently urges the voice tube 26 to an equilibrium position from its mounting point on the basket 36.

The cone 24 rests inside a concave aspect of the speaker basket 36 and is resiliently attached to an outer ring of the basket 36 by means of a resilient surround 25. The voice tube 26 is received in an opening at the apex of the cone 24 and fused thereto allowing the voice tube 26 to drive the cone into and out of the concavity of the speaker basket 36. Suitably energizing either of the first voice coil 46 or the second voice coil 48 will move the voice coil 26 axially.

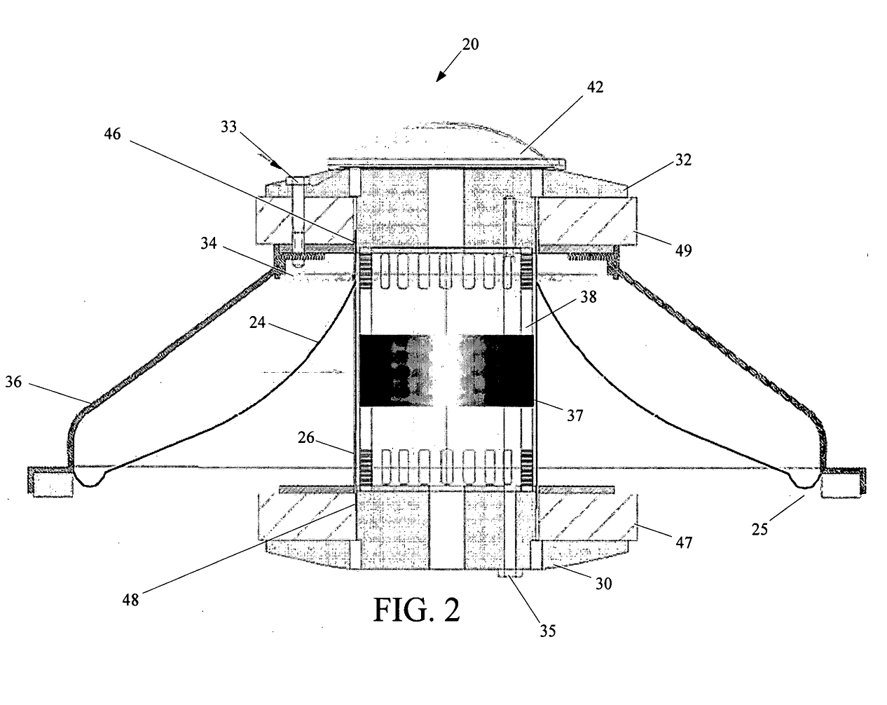

Referring to FIG. 2, a cross-sectional view of the inventive speaker 20 yields a better understanding of the movement of the voice tube 26 and cone 24 in operation. As described above, the basket 36 is the framework onto which the second magnet 49 is secured by bolts 33. The second ferrite pole piece 32 nests within the second magnet 32 and supports the vented end cap 42. The cone 24 is also secured to the outer rim of the basket 36 by means of the resilient surround 25.

In the presently preferred embodiment, the heat sink 38 is received into a first groove defined in an aspect of the first ferrite pole piece 30 and a second groove defined in the second ferrite pole piece 32. The voice tube 26 is placed around the heat sink 38 as the heat sink 38 rests in the first and second defined gooves, defining an interspace between the first ferrite pole piece 30 and the second ferrite pole piece 32. The voice tube 26 is allowed to slide freely over the heat sink 38. Defined pockets between the first magnet 47, the first ferrite pole piece 30, the second magnet 49, and the second ferrite pole piece 32 extend the sliding range of the voice tube as it travels over the heat sink 38. The spider 34 maintains a radial relationship between the basket 36 and the voice tube 26 while freely allowing radial movement between the first magnet 49 and the second magnet 47. A Teflon® bearing surface 37 between the heat sink 38 and the voice tube 26 prevents static friction or stiction from impairing the free movement of the voice tube 26 within the second groove.

The first magnet 47 and the first ferrite pole piece 30 are bolted to the second magnet 49 against the structural rigidity of the heat sink 38 to form a structural unit that encloses the voice tube 26 without holding the voice tube 26 fixed with respect to the basket 36. A series of bolts 35 retain the pole pieces 30 and 32 against the axial rigidity heat sink 38 to provide a fixed spatial relationship between the magnets 47, 49, the basket 36, and the path of the voice tube 26.

As the discussion above indicates, the voice tube 26 may be driven by suitably energizing either the first voice coil 48 or the second voice coil 46 or both. As in conventional loudspeakers, this motivation drives the voice tube 26 to oscillate axially either toward or away from the second magnet 49 according to the exciting signal applied to the voice coil. The movement of the voice tube 26, in turn, imparts movement to the cone 24 producing an acoustic wave on either side of the cone 24.

If, for example, the first voice coil 48 is excited as the principle electromotive force on the voice tube 26, the second voice coil 46 may be used in several advantageous ways. Where the acceleration of the voice tube 26 is not sufficient to provide the desired acoustic wave, the second voice coil 46 may be energized with a similar signal as the first voice coil 48, thereby increasing the electromotive force applied to the voice tube 26.

To attenuate the resonant response of the system to excitation of the first voice coil 48, the second voice coil 46 may be energized with a sinusoid that is of opposing polarity and proportionate magnitude to the resonant frequency present in the signal at the first voice coil 48. Indeed, an inductor, resistor, and capacitor (not shown) might be appropriately selected to make a passive damping circuit as the movement of the second voice coil 46 in proximity to the first magnet 47 generates a signal, thereby suitably dampening the resonance.

Additionally, as a strategy to dissipate heat uniformly from the inventive loudspeaker assembly 20, the voice coils may be alternately energized to “share the load” when the driver is to be driven at less than the full acceleration of the voice tube 26 without adversely affecting the response of the cone 24.

An amplifier with a suitable digital switching network may selectively energize the first voice coil 48 and the second voice coil 46 to alternately exploit both of the accelerative and decelerative abilities of the paired coils 46, 48. An accelerometer advantageously placed on the cone 24 or voice tube 26 would monitor the accelerations and allow a processor to selectively amplify and damp the movement of the system as appropriate to ideally reproduce the desired acoustic wave.

Similarly, the digital switching network might include thermocouples or other thermosensitive indicators that would generate signals indicative of the temperatures of the first magnet 30 or the first pole piece 30 and the second magnet 49 and the second pole piece 32. Selectively, the switching network alternates which voice coil, the first 48 or the second 46 receives the primary energizing signal, while the remaining voice coil receives the attenuate/amplify signal, thereby allowing a hotter magnet and pole piece to cool as the cooler magnet and pole piece are tasked with driving the voice tube 26.

Because the movement of a voice coil through a magnetic field will generate a signal in the windings of the voice coil, the coil that is not instantaneously driving coil, may itself be used as the accelerometer as the signal that is generated in the windings will be indicative of the movement through the magnetic field. A suitable processor will use the generated signal to sense the magnitude of the acceleration on the voice tube 26.

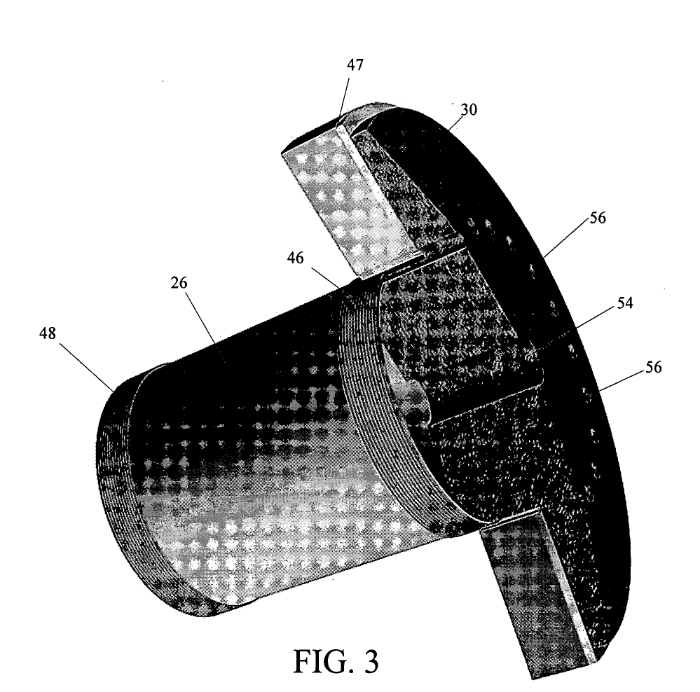

Referring now to FIG. 3, in the presently preferred embodiment, the first and second magnets 47 and 49 are preferably identical and symmetrically arranged about the heat sink 38 (not shown). By example, the first magnet 47 includes a ferrite pole piece 30 nested within a center or the toroidal first magnet 47. The pole piece 30 when placed in nesting relationship with the magnet 47 defines a cavity to contain the voice tube 26 and a flange portion. An area of the pole piece 30 advantageous includes a plurality of airflow holes 56 that have a longitudinal axis approximately parallel to the longitudinal axis of the voice tube 26. The airflow holes 56 prevent elastic damping of the axial movement of the voice tube 26 in defined cavity between the pole piece 30 and the magnet 47. The pole piece 30 also includes a center-line airflow hole 54 that is preferably co-located with the longitudinal axis of the voice tube 26 to allow cooling of the voice tube 26 and magnets 47, 49 by induced movement of air by movement of the cone 24 (not shown). The airflow hole 54 allows convective cooling of the heat sink 38 (not shown for clarity of the illustration) as the air passes through the interior of the heat sink 38 along the longitudinal axis of the voice tube 26.

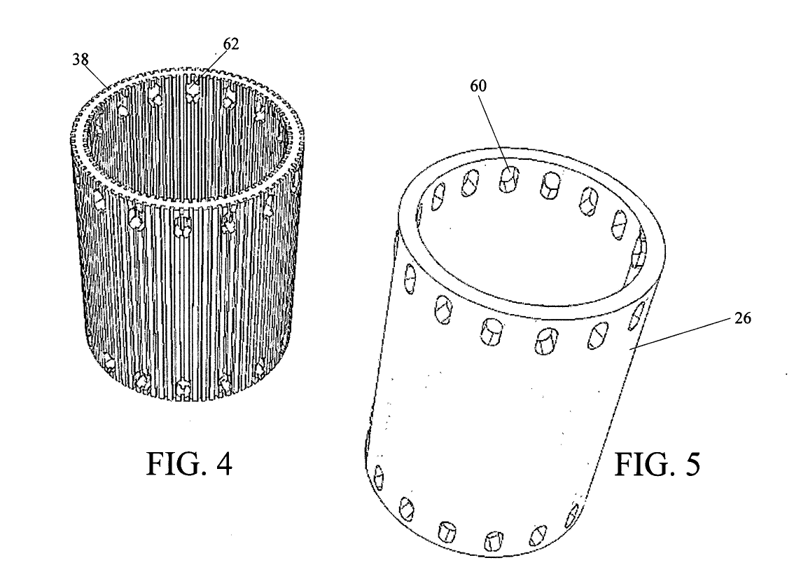

FIG. 4 illustrates a perspective view of the heat sink 38. The heat sink 38 optionally includes the plurality of holes 62 located at the ends of the heat sink 38 and placed to allow a laminar flow of air in an operative space between the voice tube 26 (not shown) and the heat sink 38 allowing for more effective cooling and freer movement of the voice tube 26. Inner and outer surface of the heat sink 38 includes longitudinal fins for allowing more efficient heat dissipation while also providing structural rigidity against axially compressive forces exerted by the first and second magnets 47, 49 when placed in opposed relationship at the axial ends. Optimally, the heat sink 38 is fabricated of a non-ferric metal advantageously conductive of heat. Aluminum provides suitable rigidity, thermal conductivity and is suitably inexpensive for fabricating a heat sink 38.

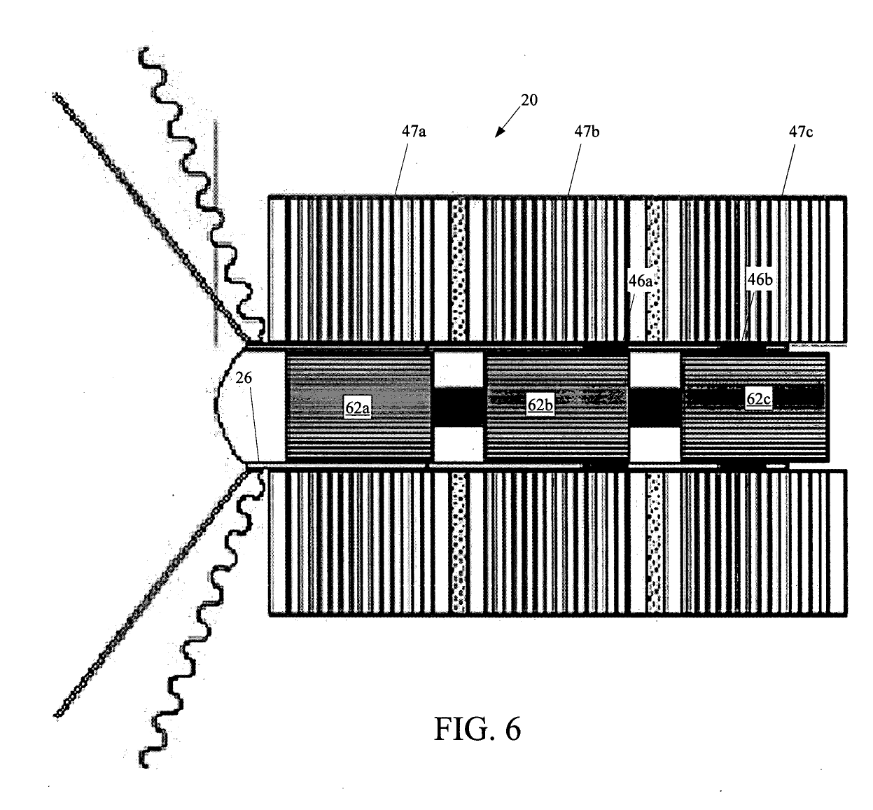

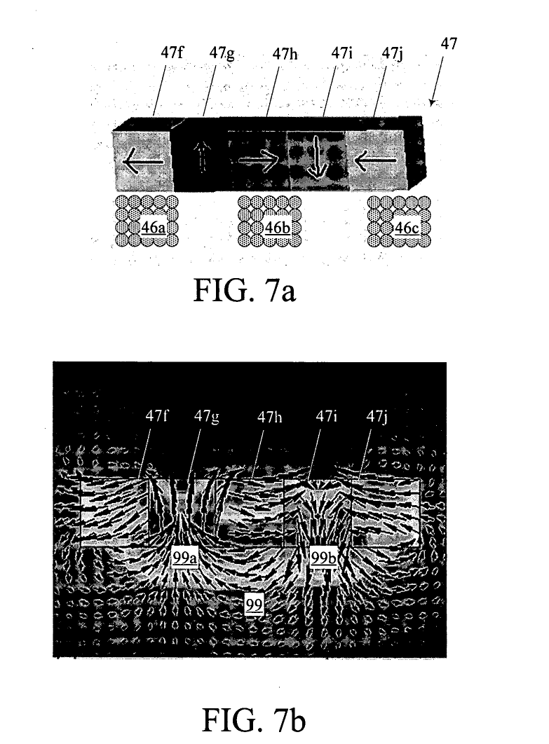

One embodiment of a voice tube 26 is shown in perspective view in FIG. 5; the voice tube 26 is shown without the first and second coils 46 and 48. Located at each end of the tube 26 are holes 60. In previous views, the holes 60 are not shown because they are covered by the coils 46 and 48. When the heat sink 38 is inserted into the tube 26, the holes 62 line up with the holes 60, thereby allowing air to carry heat from the coils through the holes 60 and 62 into the inner cavity of the heat sink 38 for expulsion through the hole 54 in the pole piece 30 (FIG. 3).

Referring to FIGS. 1, 2, 4, and 5, as the speaker 20 is operating and the cone 24 is in motion, the cone 24 acts on the surrounding air to generate sound. As the cone 24 moves it generates waves of high and low pressure transmitted in the air away from the speaker toward a listener. Similarly, as the pressure on the concave side of the cone 24 rises as the cone 24 moves outward, the pressure of the air at the convex side of the cone is dropped. The lower pressure draws air through the holes 54 and 56 of the second magnet 32 and holes 60 and 62 of the heat sink 38 and voice tube 26, into the cavity of the tube 26 and out the hole 54 defined in the first magnet 47. The air passing through the tube 26 receives heat to be removed from the fins of the heat sink 38.

Referring to FIG. 6, a multiple magnet dual coil configuration of the inventive loudspeaker assembly 20. One skilled in the art will readily appreciate that two aspects of the invention may readily be varied without departing from the spirit of the invention: First, the voice coils 46a, 46b and the magnets 62a, 62b, and 62c may be interchanged without affecting the operation of the inventive loudspeaker assembly 20 (stationary voice coils may be substituted for stationary magnets while the magnets may be affixed to the voice tube 26 for similar operation though only the stationary magnet configuration has been illustrated). Second, the number of magnets 47a, 47b, and 47c may be varied according to objectives the loudspeaker assembly 20 designer in order to optimize movement through the range of voice tube 26 motion over the several heat sinks 62a, 62b, and 62c. There is no reason to maintain a one-to-one ratio between the magnets and the voice coils.

In at least one embodiment of the inventive loudspeaker assembly 20, the number of magnets and the voice coils are selected in a manner that the geometric relationship between any voice coil and any magnet is distinct from others presented in the configuration. Thus, as in FIG. 6, the distance between a second voice coil 46b and a third magnet 47c is distinct from the distance between the first voice coil 46a and a second magnet 47b. Because the flux strength varies geometrically with the inverse of distance, throughout the range movement of the voice tube 26 there will generally be a voice coil 46 magnet 47 pair that will be in a relatively close special relationship. Advantageously switching from energizing one or more voice coils 46 to a distinct set of voice coils 46 increases efficiency to that achievable by the most proximate voice coil 46 and magnet 47 pair. By rapidly changing the energized voice coil to the optimum voice coil 46 magnet 47 pair, the accumulated non-dissipated heat from any one voice coil 46 magnet 47 pair.

The spaced apart configuration and arrangement of poles of the magnets 47a, 47b, and 47c tends to constructively add to the intensity of the magnetic field present in an interspace between any two of the magnets. A focusing effect is notable in the interspace and speakers configured with at least two magnets demonstrate an efficiency not present with single magnet configurations.

Referring to FIGS. 7a and 7b, the magnet assembly 47 configuration may comprise a Halbach array that has the effect of multiple magnets of alternating polarity. The late Klaus Halbach of Lawrence Livermore National Laboratories discovered an interesting permanent magnet configuration that concentrates magnetic flux on one side of the array and cancels it on the other. He originally designed it for focusing the beams of particle accelerators but in loudspeaker assemblies Halbach arrays have advantages that include minimized drag from eddy current effects (drag decreases as speed increases), reduced power consumption, and reduced exposure of the ambient to high magnetic fields. The flux 99 shows a distinctive pattern that is very similar to a flux pattern that alternating horseshoe magnets of great strength present.

Multiple voice coils 46a, 46b, and 46c energized with suitable polarity will receive electromagnetic force between an apparent south magnetic pole 99a and an apparent north magnetic pole 99b located at magnet segments 47g and 47i respectively. As perceived by the voice coil 46b for example, the voice coil 46b windings provide two distinct and strong electromagnetic forced between the north pole 99a and the voice coil 46b and the apparent south pole 99b and the voice coil 46b. The voice coil 46a may be suitably energized to add the electromotive force between the voice coil 46a and the apparent south pole 99a. Similarly, the voice coil 46c may be suitably energized to add the electromotive force available between the north pole. Remembering that the forces may be either additive or opposed, the selection and amplitude of the voice coils 46 to energize can suitably motivate the movement of the magnet assembly 47 relative to the voice coils 46a, 46b, and 46c, whether the magnet assembly 47 or the coils 46 are stationary relative to the basket 36 (FIGS. 1 and 2).

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A voice tube assembly for a loudspeaker, the loudspeaker including a basket, a cone, and a spider, the voice tube assembly comprising:
a first magnet, the first magnet being configured for attachment onto the basket, the magnet having a principle axis;
a voice tube of non-ferrous material, the voice tube comprising a cylindrical sleeve having a first extremity, a second extremity, and a cylinder axis, the cylinder axis is arranged to coincide with the principle axis;
a first voice coil of conductive wire wrapped around the first extremity; and
a second voice coil of conductive wire wrapped around the second extremity.

2. The voice tube assembly of claim 1, further including:
a second magnet, the second magnet configured the magnet being coaxial with the first magnet and spaced apart therefrom to form an interspace.

3. The voice tube assembly of claim 2, wherein a pole of the second magnet is oriented relative to a pole of the first magnet to concentrate a resulting magnetic field in the interspace.

4. The voice tube assembly of claim 2, wherein the second magnet includes a second ferrite pole piece.

5. The voice tube assembly of claim 4, wherein the second ferrite pole piece includes vents configured to allow movement of air past the second ferrite pole piece.

6. The voice tube assembly of claim 2, wherein the second magnet comprises a plurality of spaced apart magnets.

7. The voice tube assembly of claim 2, wherein each of the plurality of the spaced apart magnets are a circular magnet, each having an axis located at a center of the circular magnet and being configured to be coaxial with the principal axis.

8. The voice tube assembly of claim 2, further including a heat sink, the heat sink of nonferrous material and configured to engage a first surface of the first magnet and a second surface of the second magnet thereby to maintain the spaced apart relationship of the first and the second magnets.

9. The voice tube assembly of claim 8, wherein the heat sink is elongated in shape and has a heat sink axis that is coaxial with the principal axis.

10. The voice tube assembly of claim 9, wherein the heat sink is substantially cylindrical in shape.

11. The voice tube assembly of claim 9, wherein the heat sink has an outer surface.

12. The voice tube assembly of claim 11, wherein the outer surface includes a bearing surface.

13. The voice tube assembly of claim 12, wherein the bearing surface includes Teflon®.

14. The voice tube assembly of claim 12, wherein the outer surface is finned to dissipate heat.

15. The voice tube assembly of claim 8, wherein the heat sink includes vent holes.

16. The voice tube assembly of claim 8, wherein the heat sink includes an inner surface.

17. The voice tube assembly of claim 16, wherein the inner surface is finned to dissipate heat.

18. The voice tube assembly of claim 1, wherein the first magnet includes a first ferrite pole piece.

19. The voice tube assembly of claim 18, wherein the first ferrite pole piece includes vents configured to allow movement of air past the first ferrite pole piece.

20. The voice tube assembly of claim 1, wherein the first voice coil is configured to impart a first electromotive force upon the voice tube when a first current passes through the coil.

21. The voice tube assembly of claim 20, wherein the second voice coil is configured to impart a second electromotive force upon the voice tube when a second current passes through the coil.

22. The voice tube assembly of claim 21, wherein the second current is selected to impart the second electromotive force to suitably enhance the first electromotive force imparted upon the voice tube thereby to produce a desired acoustic wave based upon the first current.

23. The voice tube assembly of claim 21, wherein the first current is selected to impart the first electromotive force to suitably enhance the second electromotive force imparted upon the voice tube thereby to produce a desired acoustic wave based upon the second current.

24. The voice tube assembly of claim 20, wherein a second current is generated in the second voice coil due to movement of the voice tube.

25. The voice tube assembly of claim 24, wherein the second current is measured to determine a magnitude of the movement of the voice tube.

26. The voice tube assembly of claim 1, the voice tube assembly further comprising:
a third voice coil of conductive wire wrapped around the voice tube at a position between and spaced apart from both the first voice coil and the second voice coil.

27. The voice tube assembly of claim 26, wherein:
the third voice coil comprises a plurality of voice coils spaced apart from each other, each of the plurality of voice coils being separately energizable.

28. The voice tube assembly of claim 1, wherein the first magnet is a Halbach array.

28. The voice tube assembly of claim 28, wherein the Halbach array comprises a plurality of magnet segments.

30. The voice tube assembly of claim 29, wherein each of the plurality of magnet segments are circular magnets, the circular magnets having an axis at a center of the circular magnet and configured to be coaxial with the principle axis.

31. The voice tube assembly of claim 30, wherein the plurality is an odd number of magnet segments.

32. A method for motivating a voice tube assembly in a loudspeaker, the loudspeaker including a basket, a cone, and a spider:
selectively energizing a first voice coil of conductive wire wrapped around a first extremity of a voice tube of non-ferrous material, the voice tube comprising a cylindrical sleeve having the first extremity, an opposed second extremity, and a cylinder axis, the first extremity in operational proximity to a first magnet; and
selectively energizing a second voice coil of conductive wire wrapped around the second extremity in operational proximity to a second magnet.

33. The method of claim 1, further comprising:
dissipating heat in the voice tube through a heat sink, the heat sink of nonferrous material and configured to engage a first surface of the first magnet and a second surface of the second magnet thereby to maintain the spaced apart relationship of the first and the second magnets.

34. The method of claim 33, wherein the heat sink is elongated in shape and has a heat sink axis that is coaxial with the principal axis.

35. The method of claim 34, wherein the heat sink is substantially cylindrical in shape.

36. The method of claim 34, wherein the heat sink has an outer surface.

37. The method of claim 36, wherein the outer surface includes a bearing surface.

38. The method of claim 37, wherein the bearing surface includes Teflon®.

39. The method of claim 36, wherein the outer surface is finned to dissipate heat.

40. The method of claim 35, wherein the heat sink includes vent holes.

41. The method of claim 35, wherein the heat sink includes an inner surface.

42. The method of claim 41, wherein the inner surface is finned to dissipate heat.

43. The method of claim 42, wherein the first magnet includes a first ferrite pole piece.

44. The method of claim 43, wherein the first ferrite pole piece includes vents configured to allow movement of air past the first ferrite pole piece.

45. The method of claim 32, further including:
a second magnet, the second magnet configured the magnet being coaxial with the first magnet and spaced apart therefrom.

46. The method of claim 45, wherein the second magnet includes a second ferrite pole piece.

47. The method of claim 46, wherein the second ferrite pole piece includes vents configured to allow movement of air past the second ferrite pole piece.

48. The method of claim 45, wherein the second magnet comprises a plurality of spaced apart magnets to form an interspace.

49. The method of claim 48, wherein a pole of the second magnet is oriented relative to a pole of the first magnet to concentrate a resulting magnetic field in the interspace.

50. The method of claim 48, wherein each of the plurality of the spaced apart magnets are a circular magnet, each having an axis located at a center of the circular magnet and being configured to be coaxial with the first magnet.

51. The method of claim 32, wherein the first voice coil is configured to impart a first electromotive force upon the voice tube when a first current passes through the coil.

52. The method of claim 51, wherein the second voice coil is configured to impart a second electromotive force upon the voice tube when a second current passes through the coil.

53. The method of claim 52, wherein the second current is selected to impart the second electromotive force to suitably enhance the first electromotive force imparted upon the voice tube thereby to produce a desired acoustic wave based upon the first current.

54. The method of claim 52, wherein the first current is selected to impart the first electromotive force to suitably enhance the second electromotive force imparted upon the voice tube thereby to produce a desired acoustic wave based upon the second current.

55. The method of claim 51, wherein a second current is generated in the second voice coil due to movement of the voice tube.

56. The method of claim 55, wherein the second current is measured to determine a magnitude of the movement of the voice tube.

57. The method of claim 32, the voice tube assembly further comprising:
a third voice coil of conductive wire wrapped around the voice tube at a position between and spaced apart from both the first voice coil and the second voice coil.

58. The method of claim 57, wherein:
the third voice coil comprises a plurality of voice coils spaced apart from each other.

59. The method of claim 58, the method further comprising:
suitably and distinctly energizing each of the plurality of voice coils according to a desired movement of the voice tube.

60. The method of claim 32, wherein the first magnet is a Halbach array.

61. The method of claim 60, wherein the Halbach array comprises a plurality of magnet segments.

62. The method of claim 61, wherein each of the plurality of magnet segments are circular magnets, the circular magnets having an axis at a center of the circular magnet and configured to be coaxial with the first magnet.

63. The voice tube assembly of claim 62, wherein the plurality is an odd number.
